(19) United States
(12) Patent Application Publication
(10) Pub. No.: US 2021/0179260 A1
(43) Pub. Date: Jun. 17, 2021

(54) AIRCRAFT LANDING GEAR WITH WING CONFIGURATION FOR ENABLING A SMOOTH TAKEOFF AND LANDING

(71) Applicant: Kfir Baranes, Lake Worth, FL (US)

(72) Inventor: Kfir Baranes, Lake Worth, FL (US)

(21) Appl. No.: 16/711,782

(22) Filed: Dec. 12, 2019

(51) Int. Cl. B64C 25/12; B64C 25/52; B64C 25/34; B64C 3/10

(52) U.S. Cl. CPC B64C 25/12; B64C 3/10; B64C 25/34; B64C 25/52

(57) ABSTRACT

A landing gear for aircraft configured for providing lift includes an elongated winged structure having a first end portion and a second end portion. The first portion of each elongated winged structure is attached to a portion of the aircraft. The second portion of the elongated winged structure is configured to connect with a portion of the landing gear. Each elongated winged structure has an upward facing side and a downward facing side. The winged structure's upward facing side and downward facing side create a distinct shape configured to provide optimal lift when the aircraft is moving forward.

### CROSS-REFERENCE TO RELATED APPLICATIONS

Not applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of aerospace development and engineering, and more specifically to the field of aerospace engineering in aircraft structures.

### BACKGROUND

Landing gear is one of the critical subsystems of an aircraft. The need to design landing gear with minimum weight, minimum volume, high performance, improved life, and reduced life cycle cost have posed many challenges to landing gear designers and practitioners. Mechanical malfunctions in aircraft wings and landing gears are one of the most common problems in the airline industry. In 2016, landing gear systems failure accounted for approximately 9% of the failures suffered on Boeing aircrafts, and 10% of the total failures reported for the aerospace industry. In 2019 alone, Boeing changed its new 737 model's wing and landing gear due to repeated structural malfunctions in both designs. These structural defects can create issues which may result in significant damage to the aircraft, diminish aircraft performance, and cause injury death to its passengers. These failures can also cause the aircraft to burn significantly more fuel.

Fuel is a significant operating cost for airlines. Fuel makes up between 15% and 20% percent of total expenses in the airline industry according to Airline Financial Data. In 2018, jet fuel prices were 50% up from where they were in 2017, while global demand for air travel continues to drive up fuel consumption. By the end of this year, fuel costs will constitute 25% of total expenditure in the industry. In July 2019 alone, U.S. airlines spent $3 billion on fuel. A reduction in these numbers could save airlines billions of dollars and increase aviation sustainability. Accordingly, existing deficiencies in current aircraft landing gear and wing technology increases these operational risks and expenses.

It is essential to reduce the landing gear design and development cycle time while meeting all the regulatory and safety requirements. Challenges in landing gear and wing design include the need to design both structures with minimum volume, minimum weight, fuel efficiency, and high lift performance. Landing gears are critical to ensure manageable aircraft landing and take-off. Additionally, upward-folded wings increase lift, decrease lift-induced drags, and reduce fuel consumption. What is currently needed in the airline industry is to to enhance the performance of these structures by creating a landing gear technology that transforms into a wing. This structure could increase fuel efficiency, improve aircraft performance, and boost airline safety. Further, this improved technology could correct unstable landings and take-offs, failure or delays in skid ejections, and lift instability.

Current landing gear technology has failed to remedy common mechanical issues with landing gears and wings to the detriment of the airline industry and airline customers. Therefore, a need exists to improve over the prior art and more particularly, for a high performance landing gear with upward wings that provide optimal lift to an aircraft for a smoother take-off and landing.

### SUMMARY

A landing gear apparatus with two attached winged structures for an aircraft configured for providing lift for an aircraft is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a landing gear apparatus with two attached winged structures for an aircraft configured for providing lift for an aircraft is disclosed. The landing gear includes an elongated winged structure having a first end portion and a second end portion. The first portion of each elongated winged structure is attached to a portion of the aircraft. The second portion of the elongated winged structure is configured to connect with a portion of the landing gear. Each elongated winged structure has an upward facing side and a downward facing side. The winged structure's upward facing side and downward facing side create a distinct shape. This distinct shape created from each winged structure's upward facing side and downward facing side is configured to provide optimal lift when the aircraft is moving forward and gearing up for take-off.

In another embodiment, an aircraft is disclosed. The aircraft includes a first elongated winged element having a first portion and a second portion. A first attaching means is configured for attaching the first end portion of the first elongated winged element to a first portion of the aircraft. The first elongated winged element is disposed on a first side of a sagittal plane of the aircraft at least a first 40 degree angle relative to the sagittal plane. A second attaching means is configured for attaching the first end portion of the second elongated winged element to a second portion of the aircraft. The second elongated winged element is disposed on a second side of the sagittal plane of the aircraft at least a second 40-degree angle relative to the sagittal plane. The second portion of the elongated wing element is configured to at least one of provide and connect with a landing element. Each elongated winged element has an upward facing side and a downward facing side, wherein the upward facing side and downward facing side define a shape configured to provide lift when the aircraft is moving forward.

In yet another embodiment, a method for providing lift to an aircraft is disclosed. The method comprises attaching at least one elongated winged element to a portion of the aircraft. Each elongated winged has a first end portion and a second portion. A first attaching means attaches the first end portion of each elongated winged element to a portion of the aircraft. A second portion of the elongated wing element is configured to at least one of provide and connect with a landing element. Each elongated winged element has an upward facing side and a downward facing side. The upward facing side and downward facing side define a shape configured to provide lift when the aircraft is moving forward.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a front view of a landing gear for aircraft configured for providing lift, wherein the aircraft is in a landing configuration, according to an example embodiment of the present invention;

FIG. 2 is a front view of a landing gear for aircraft configured for providing lift, wherein the aircraft is moving from a landing configuration to a flying configuration, according to an example embodiment of the present invention;

FIG. 3 is a front view of a landing gear for aircraft configured for providing lift, wherein the aircraft is in a flying configuration, according to an example embodiment of the present invention;

FIG. 4 is a side view of a landing gear for aircraft configured for providing lift, wherein the aircraft is in a flying configuration, according to an example embodiment of the present invention; and

FIG. 5 is a perspective side view of an elongated wing element during the production of lift, wherein the airflow meeting the frontward facing side of the elongated winged element is forced to split over and under the upward facing side and downward facing side of the elongated winged element, according to an example embodiment of the present invention.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The present invention improves upon the prior art by providing landing gear with minimum weight, minimum volume, reduced life cycle cost, and short development cycle time by employing landing gear that double as wing structures that provide optimal lift to an aircraft during take off and landing. Specifically, the present invention improves upon the prior art by providing a landing gear with two attached winged structures for an aircraft configured for providing lift for an aircraft. The landing gear includes an elongated winged structure having a first end portion and a second end portion. The first portion of each elongated winged structure is attached to a portion of the aircraft. The second portion of the elongated winged structure is configured to connect with a portion of the landing gear. Each elongated winged structure has an upward facing side and a downward facing side. The winged structure's upward facing side and downward facing side create a distinct shape. This distinct shape created from each winged structure's upward facing side and downward facing side is configured to provide optimal lift when the aircraft is moving forward and gearing up for take-off.

As used herein, the term aircraft means any one of a number of vehicles that include one or more fixed wings attached to a fuselage or aircraft body. The term aircraft is intended to include, but is not limited to, next generation and future designs for large transport aircraft, general aviation aircraft, regional aircraft, commercial aircraft, commuter aircraft, business jets, personal aircraft, unmanned aerial vehicles (UAVs), model aircraft, toy airplanes, and many others. Embodiments will be described herein with respect to a conventional helicopter, and it is to be understood that some or all of the described embodiments may also be applied to other types of aircraft, in alternate embodiments. It is also understood that the term aircraft may also mean any self propelled vehicle that for which providing upward lift may be desirable. Therefore, the scope of at least some of the appended claims is intended to encompass those alternate embodiments.

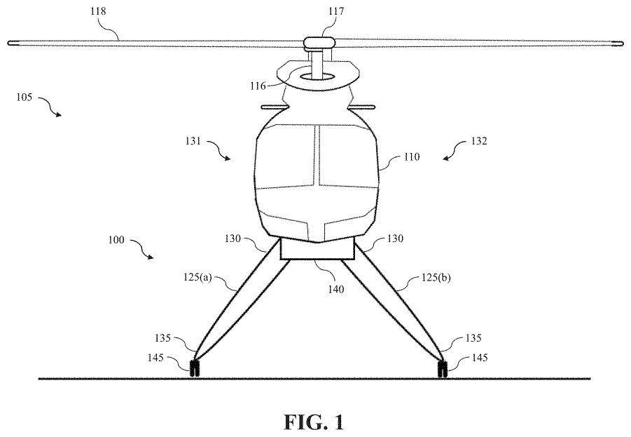

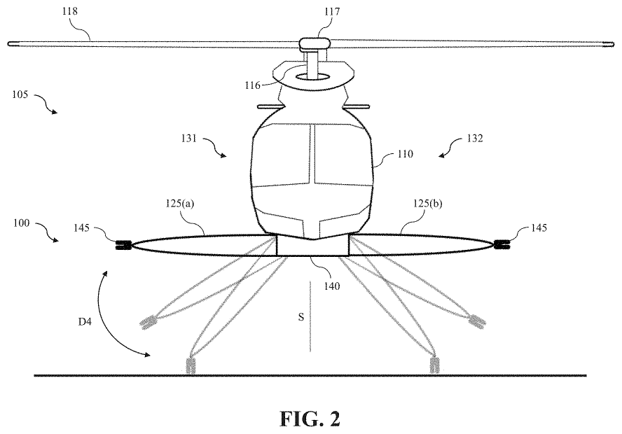

Referring now to the Figures, FIGS. 1-4 illustrate a landing gear 100 for aircraft 105 configured for providing lift according to an example embodiment of the present invention and will be discussed together for ease of reference. The major components of the aircraft include a fuselage 110, a main rotor system 115, a tail rotor system 120, and the landing gear 100. The fuselage 110 is the main body section of the aircraft that houses the cabin that holds the crew, passengers, and cargo. The fuselage 110 also houses the engine, transmission, and flight controls (not shown). The fuselage 110 extends from a nose end 106 to a tail end 107 along a sagittal plane (represented by line S in FIG. 2) of the aircraft 105.

The main rotor system 115 is the rotating part of the aircraft 105 which generates lift, as described further below. The main rotor system 115 consists of a mast 116, a hub 117, and a plurality of rotor blades 118. The mast 116 is a hollow cylindrical metal shaft which extends upwards from and is driven and sometimes supported by the transmission. At the top of the mast 116 is the attachment point for the rotor blades called the hub 117. The rotor blades 118 are attached to the hub 117 by a series of hinges (not shown), which allow the rotor blades to move independently of the others. The tail rotor system 120 is mounted on the tail end 107 of the aircraft and includes plurality of rotor blades 121. The tail rotor system counteracts the torque effect created by the rotation of the main rotor system, and controls the direction in which the aircraft travels.

The landing gear is one of the critical subsystems of the aircraft and is often configured along with the aircraft structure because of its substantial influence on the aircraft structural configuration itself. The purpose of the landing gear in the aircraft is to provide a suspension system during taxi, take-off and landing. It is designed to absorb and dissipate the kinetic energy of landing impact, thereby reducing the impact loads transmitted to the fuselage.

The landing gear also facilitates braking of the aircraft using a wheel braking system and provides directional control of the aircraft on ground using a wheel steering system. It is often made retractable to minimize the aerodynamic drag on the aircraft while flying. The present invention improves upon the need for landing gear with minimum weight, minimum volume, reduced life cycle cost, and short development cycle time by employing landing gear that double as wing structures to provide optimal lift to an aircraft during take off and landing.

FIG. 2 is a front view of a landing gear for aircraft configured for providing lift, wherein the aircraft is moving from a landing configuration to a flying configuration, according to an example embodiment of the present invention. During takeoff, the aircraft is acted upon by four aerodynamic forces: thrust, drag, weight, and lift. Thrust is the force (in the direction of arrowed line F1) that is produced by airfoils, such as propellers, rotor blades and wings, that oppose or overcome the force of drag. As further discussed below, an airfoil is any surface that produces more lift than drag when passing through the air at a suitable angle. Drag is a rearward, impeding force (in the direction of arrowed line F2) caused by disruption of airflow by the airfoils, and other protruding objects. Drag opposes thrust and acts rearward parallel to the relative wind. Weight is the combined load of the aircraft itself, the crew, the fuel, and the cargo or baggage. Weight pulls the aircraft downward because of the force (in the direction of arrowed line F3) of gravity, opposes lift, and acts vertically downward through the aircraft's center of gravity. Lift opposes the downward force of weight (in the direction of arrowed line F4) and as further discussed below, is produced by the dynamic effect of the wind acting on the airfoil and acts perpendicular to the flightpath through the center of lift.

Based on the foregoing factors, the landing gear 100 includes at least one elongated winged element 125(a), 125(b) to obtain a useful reaction of lift as the aircraft moves from a landing configuration to a flying configuration, and through the air. Each elongated winged element 125(a), 125(h) includes a first end portion 130 and a second end portion 135. It should also be appreciated that each elongated wing element may be comprised of a wing, blade, propeller, rotor, turbine, or any other suitable method known in the art.

In the present embodiment, the landing gear includes two elongated wing elements 125(a), 125(h) arranged at least at a 0 degree angle relative to the sagittal plane of the aircraft. The first elongated wing element 125(a) is located on a first side 131 of a sagittal plane of the aircraft 105 and the second elongated wing element 125(h) is located on a second side 132 of the sagittal plane of the aircraft 105. Each elongated wing element is comprised of a rectangular wing due to its stability, control, and aerodynamic efficiency. The aerodynamic efficiency of a wing is expressed as its lift-to-drag ratio. The lift-to-drag ratio, or L/D ratio, is the amount of lift generated by a wing, divided by the aerodynamic drag it creates by moving through the air. A higher or more favorable L/D ratio is typically one of the major goals in aircraft design. Specifically, because the required lift is set by the weight of an aircraft, delivering that lift with lower drag leads directly to better fuel economy in an aircraft, climb performance, and glide ratio.

Each elongated winged element 125(a), 125(b) may include a framework that is made up of spars and ribs. The spars (not shown) are the main structural members of each elongated winged element. The spars extend from the fuselage to the tip of the second end portion 135 of each elongated winged element and support all distributed loads, as well as concentrated weights such as the fuselage, landing gear, and engines. In one embodiment, each elongated winged element includes two spars. The first spar may be located near the frontward facing side 128 of each elongated winged element and the second spar is located about two-thirds of the distance toward the rearward facing side 129 of each elongated winged element. The spars may be comprised of solid extruded aluminum or aluminum extrusions riveted together to form the spar, wood, composite materials depending on the design criteria of a specific aircraft, or any other suitable material known in the art.

The ribs (not shown) may be structural crosspieces that combine with the spars to make up the framework of each elongated winged element. The ribs define the shape of each elongated winged element and extend from the frontward facing side 128 of each elongated winged element to the rearward facing side 129 of each elongated winged element. In operation, the ribs transmit the load from an external skin attached to each elongated winged element to the spars. The ribs may be comprised of metal, wood, plastic, composites, foam, or any other suitable material known in the art.

The external skin may be attached to the framework comprising each elongated winged element 125(a), 125(b). In operation, the external skin carries part of the loads imposed during flight. The external skin also transfers the stresses to the ribs of each elongated winged element 125(a), 125(b). The ribs, in turn, transfer the loads to the spars of each elongated winged element. The external skin may be made from a variety of materials such as fabric, wood, aluminum, or any other suitable material known in the art.

Each elongated winged element 125(a), 125(b) has an upward facing side 126, a downward facing side 127, a frontward facing side 128, and a rearward facing side 129. The upward facing side 126 and downward facing side 127 define a shape configured to provide lift when the aircraft 105 is moving forward (in the direction of arrowed line D1). The upward facing side 126 of each elongated wing element 125(a), 125(b) defines a curved surface such that lift is provided when the aircraft moves forward. Those of skill in the art will appreciate that the design of each elongated wing element may vary based on factors such as the desired speed at takeoff, landing and in flight, the desired rate of climb, use of the aircrafe, and size and weight of the aircraft. Additionally, each elongated winged element 125(a), 125(b) may include devices such as flaps or slats for modifying the shape and surface area of each elongated winged element to change operating characteristics in flight.

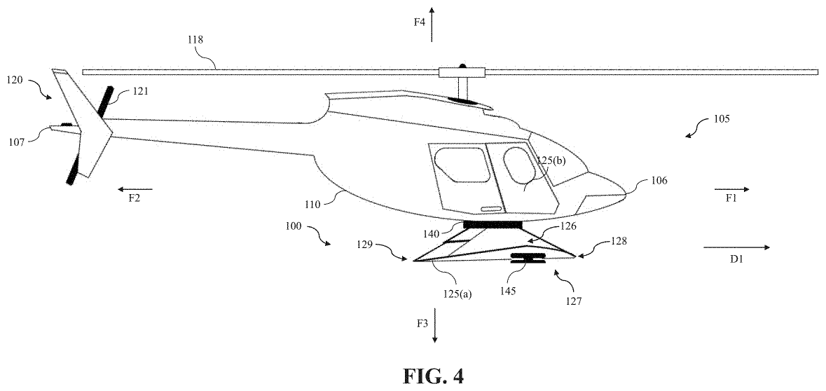

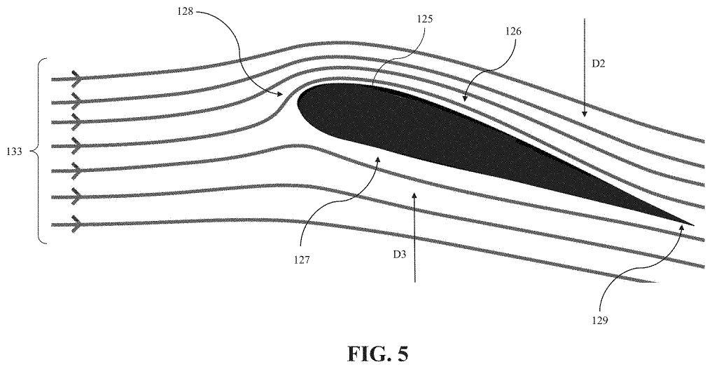

In the present embodiment, as best illustrated in FIG. 5, each elongated wing element includes a nonsymmetrical design that has a different upward facing side 126 and downward facing side 127. The upward facing side of each elongated wing element has an outwardly curved surface and the downward facing side 127 has a substantially planar surface. A symmetrical design is distinguished by having identical upward and downward facing sides. As illustrated in FIGS. 4 and 5 and further discussed below, the advantages of a nonsymmetrical design include more lift production than a symmetrical design and improved lift-to-drag ratio.

FIG. 4 is a side view of a landing gear for aircraft configured for providing lift, wherein the aircraft is in a flying configuration, and FIG. 5 is a perspective side view of an elongated wing element during the production of lift, according to an example embodiment of the present invention. In operation as the aircraft move in a forward direction, the airflow meeting the frontward facing side 128 of each elongated winged element 125(a), 125(b) is forced to split over and under the upward facing side 126 and downward facing side 127 of each elongated winged element 125(a), 125(h). The sudden change in direction over each elongated winged element 125(a), 125(b) causes an area of low pressure to form behind the frontward facing side 128 on the upward facing side 126 of each elongated winged element 125(a), 125(b). In turn, due to this pressure gradient and the viscosity of the air, the flow over each elongated winged element 125(a), 125(b) is accelerated down (in the direction of arrowed line D2) along the upward facing side 126 of each elongated winged element 125(a), 125(b). At the same time, the airflow forced under the downward facing side 127 of each elongated winged element 125(a), 125(b) is rapidly slowed or stagnated causing an area of high pressure (in the direction of arrowed line D3). This also causes the airflow to accelerate along the upward facing side 126 of each elongated winged element 125(a), 125(b). The two sections of the airflow each leave the rearward facing side 129 of each elongated winged element 125(a), 125(b) with a downward component of momentum, producing lift.

The landing gear 100 further includes a first attaching element 140 that is configured for connecting the first portion 130 of each elongated winged element 125(a), 125(b) to a portion of the aircraft 105. As illustrated in FIGS. 1-3, the first attaching element 140 defines a joint that is configured to pivot to allow each elongated winged element 125(a), 125(b) to move between a landing configuration and a flying configuration. The first attaching element may include lugs, rivets, bolts, nuts, or any other type of suitable fasteners depending on the design criteria of a specific aircraft, and such variations are within the spirit and scope of the claimed invention.

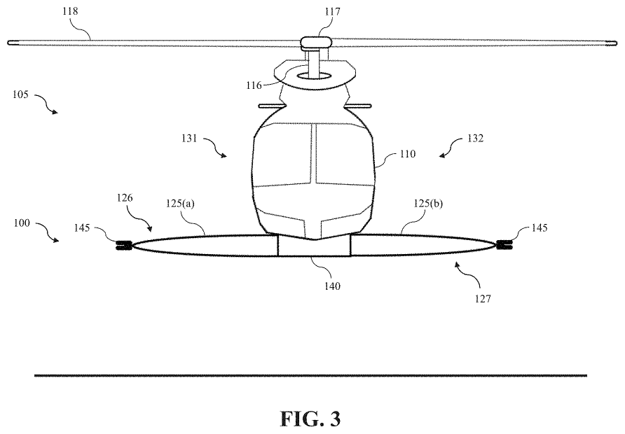

In one embodiment, an activation switch or device is configured to control each elongated winged element 125(a), 125(b). FIGS. 1 and 2 show each elongated winged element 125(a), 125(b) moving between a landing configuration to a flying configuration. In operation, as the aircraft is taking off from the ground, or after the aircraft has taken off from the grond, the activation switch or device is moved to a first position such that each elongated winged element 125(a), 125(b) is rotated away from the fuselage to at least a 60-degree angle relative to the sagittal plane of the aircraft. FIG. 2 illustrates the winged elements at a 90-degree angle relative to the sagittal plane, however, it is understood that other angles may be used and are within the spirit and scope of the present invention. FIGS. 3 and 2 show each elongated winged element 125(a), 125(b) moving between a flying configuration to a landing configuration. In operation, as the aircraft is preparing the approach and landing phase of a flight, the activation switch or device is moved to a second position such that each elongated winged element 125(a), 125(b) is rotated downward at an angle relative to the sagittal plane less than when in the flying configuration. When in the landing configuration, the the aircraft may safely land.

In the present embodiment, the first portion 130 of the first elongated wing element 125(a) is attached to the first side 131 of the fuselage and the first portion of the second elongated wing element 125(b) is attached to the second side 132 of the fuselage However, it is understood that the winged elements may also be attached at different locations that are within the spirit and scope of the present invention. The first attaching element allows each elongated winged element 125(a), 125(b) to rotate at different angles while transitioning from the landing configuration to the flying configuration or vice versa. Each elongated winged element may be attached to the fuselage at the top, mid-fuselage, or at the bottom and extend perpendicular to the sagittal plain of the aircraft or can angle up or down slightly. It should also be appreciated that each elongated winged element 125(a), 125(b) may be permanently fixed to the aircraft or fixed to the aircraft in a detachable manner, and such variations are within the spirit and scope of the claimed invention.

The second portion 135 of each elongated wing element 125(a), 125(b) is configured to at least one of provide and connect with a landing element 145. The landing element 145 comprises a landing skid, a wheel, a surface, a bubble element or any combination thereof. In the present embodiment, the landing element is comprised of a wheel and tire assembly located on the second portion 135 of each elongated wing element 125(a), 125(b). Those of skill in the art will appreciate that the landing element configuration may vary based on the number of wheels, tire sizes, pressures, type of shock absorbers, landing gear layout, retraction kinematics and bay geometry design, and such variations are within the spirit and scope of the claimed invention. It should also be appreciated that the landing gear 100 may further include retractable landing gear elements. The landing element is configured for allowing the aircraft to land on the ground.

In another embodiment, an aircraft comprising landing gear configured for providing lift is disclosed. Similar to the embodiments shown in FIGS. 1-4, the aircraft includes a first elongated winged element having a first portion and a second portion. Each elongated winged element has an upward facing side and a downward facing side. The upward facing side and downward facing side define a shape configured to provide lift when the aircraft is moving forward. The upward facing side of each elongated wing element defines a curved surface such that lift is provided when aircraft moves forward (in the direction of line F1 as illustrated in FIG. 4).

A first attaching means is configured to attach the first end portion of the first elongated winged element to a first portion of the aircraft. Unlike the embodiments shown in FIGS. 1-4, the first elongated winged element is disposed on a first side of a sagittal plane of the aircraft at least at a first 40-degree angle relative to the sagittal plane. The first attaching means further defines a joint that pivots such that the first elongated winged element moves between a landing configuration and a flying configuration (in the direction of double arrowed line D4). In the flying configuration, each elongated wing element is disposed at least at 60-degree angle relative to the sagittal plane. In the landing configuration each elongated wing element is disposed at an angle relative to the sagittal plane less than when in the flying configuration.

Similar to the embodiments shown in FIGS. 1-4, a second attaching means is configured to attach the first end portion of the second elongated winged element to a second portion of the aircraft. The second elongated winged element is disposed on a second side of the sagittal plane of the aircraft at least at a second 40-degree angle relative to the sagittal plane. The second portion of the elongated wing element is configured to at least one of provide and connect with a landing element.

In another embodiment, a method for providing lift to an aircraft is disclosed. The method includes attaching at least one elongated winged element to a portion of the aircraft. Similar to the embodiments shown in FIGS. 1-4, each elongated winged includes a first end portion and a second end portion. Each elongated winged element comprises an upward facing side and a downward facing side. The upward facing side and downward facing side define a shape that is configured to provide lift when the aircraft is moving forward.

A first attaching means is configured for attaching the first end portion of each elongated winged element to a portion of the aircraft. The first attaching means defines a joint that pivots such that the elongated wing element moves between a landing configuration and a flying configuration. In the flying configuration, each elongated wing element is disposed at least at a 60-degree angle relative to the sagittal plane. In the landing configuration, each elongated wing element is disposed at an angle relative to the sagittal plane less than when in the flying configuration.

A second portion of the elongated wing element is configured to at least one of provide and connect with a landing element. Similar to the embodiments shown in FIGS. 1-4, the landing element comprises a landing skid, a wheel, a surface, a bubble element or any combination thereof. The method further includes attaching each elongated wing element to a portion of the aircraft. Each elongated wing element is disposed at least a 0-degree angle relative to the sagittal plane. The first elongated wing element is disposed on a first side of a sagittal plane of the aircraft and the second elongated wing element is disposed on a second side of the sagittal plane of the aircraft.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A landing gear for aircraft configured for providing lift comprising:
at least one elongated winged element having a first end portion and a second end portion;
a first attaching means attaching the first portion of each elongated winged element to a portion of the aircraft;
wherein a second portion of the elongated wing element is configured to at least one of provide and connect with a landing element; and
each elongated winged element having an upward facing side and a downward facing side, wherein the upward facing side and downward facing side define a shape configured to provide lift when the aircraft is moving forward.

2. The landing gear for aircraft of claim 1, wherein the landing element comprises a landing skid, a wheel, a surface, a bubble element or any combination thereof.

3. The landing gear for aircraft of claim 1, wherein the first attaching means defines a joint that pivots so that the elongated wing element moves between a landing configuration and a flying configuration.

4. The landing gear for aircraft of claim 3, wherein the landing gear comprises two said elongated wing elements, wherein a said first elongated wing element is disposed on a first side of a sagittal plane of the aircraft and the second elongated wing element is disposed on a second side of the sagittal plane, and wherein each elongated wing element is disposed at least a 0 degree angle relative to the sagittal plane.

5. The landing gear for aircraft of claim 1, wherein the upward facing side of each elongated wing element defines a curved surface such that lift is provided when aircraft moves forward.

6. A method for providing lift to an aircraft comprising:
attaching at least one elongated winged element to a portion of the aircraft,
wherein each elongated winged having a first end portion and a second portion,
a first attaching means attaching the first end portion of each elongated winged element to a portion of the aircraft,
wherein a second portion of the elongated wing element is configured to at least one of provide and connect with a landing element; and
each elongated winged element having an upward facing side and a downward facing side, wherein the upward facing side and downward facing side define a shape configured to provide lift when the aircraft is moving forward.

7. The method of claim 6, wherein the method further comprises attaching two said elongated wing elements to a portion of the aircraft, wherein one said elongated wing element is disposed on a first side of a sagittal plane of the aircraft and the second elongated wing element is disposed on a second side of the sagittal plane, wherein each elongated wing element is disposed at least a 0 degree angle relative to the sagittal plane.

8. The method of claim 7, wherein the first attaching means defines a joint that pivots so that the elongated wing element moves between a landing configuration and a flying configuration.

9. The method of claim 8, where in the flying configuration each elongated wing element is disposed at least a 60 degree angle relative to the sagittal plane and where in landing configuration each elongated wing element is disposed at an angle relative to the sagittal plane less than when in the flying configuration.

10. The landing gear for aircraft of claim 6, wherein the landing element comprises a landing skid, a wheel, a surface, a bubble element or any combination thereof.

11. An aircraft comprising:
a first elongated winged element having a first portion and a second portion;
a first attaching means attaching the first end portion of the first elongated winged element to a first portion of the aircraft, wherein the first elongated winged element is disposed on a first side of a sagittal plane of the aircraft at least a first 40 degree angle relative to the sagittal plane;
a second attaching means attaching the first end portion of the second elongated winged element to a second portion of the aircraft, wherein the second elongated winged element is disposed on a second side of the sagittal plane of the aircraft at least a second 40 degree angle relative to the sagittal plane;
wherein the second portion of the elongated wing element is configured to at least one of provide and connect with a landing element; and,
wherein each elongated winged element has an upward facing side and a downward facing side, wherein the upward facing side and downward facing side define a shape configured to provide lift when the aircraft is moving forward.

12. The aircraft of claim 11, wherein the first attaching means defines a joint that pivots so that each elongated wing element is configured to move between a landing configuration and a flying configuration.

13. The aircraft of claim 11, wherein the upward facing side of each elongated wing element defines a curved surface such that lift is provided when aircraft moves forward.

14. The aircraft of claim 13, where in the flying configuration each elongated wing element is disposed at least a 60 degree angle relative to the sagittal plane and where in landing configuration each elongated wing element is disposed at an angle relative to the sagittal plane less than when in the flying configuration.
